(19) United States
(12) Patent Application Publication
(10) Pub. No.: US 2002/0038246 A1
(43) Pub. Date: Mar. 28, 2002

(54) Bonus information issuing system, advertisement information issuing system, digital content delivery system, and storage medium

(75) Inventor: Michihiro Nagaishi, Shimosuwa-cho (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 09/946,513

(22) Filed: Sep. 6, 2001

(30) Foreign Application Priority Data
Sep. 6, 2000 (JP) 2000-270436

(51) Int. Cl. G06F 17/60

(52) U.S. Cl. 705/14

(57) ABSTRACT

To provide a digital content delivery system that issues coupon information and advertisement information much needed by a user and outputs a digital content in an easy-to-see layout to the user. A content delivery terminal 100 includes a user information registration DB 40 for registering information designated by a user and a coupon information registration DB 44 for registering coupon information. The coupon information is searched for in the coupon information registration DB 44 based on the user-designated coupon information in the user information registration DB 40 and is then retrieved. The retrieved coupon information is added to a digital content, and the digital content with the coupon information attached thereto is then delivered to the user. The searching of the coupon information is performed by searching the coupon information agreeable to the user's interest and preference, based on the category information of the user-designated coupon information.

### BACKGROUND OF THE INVENTION

1. Field of Invention

The present invention relates to a system and a storage medium for issuing coupon information and advertisement information, and, more particularly, to a system and a storage medium for delivering a digital content with coupon information and advertisement information.

2. Description of Related Art

Known as methods and apparatuses for issuing coupon information are, for example, a coupon issuing system disclosed in Japanese Patent No. 3025615 (hereinafter referred to as a first conventional art), method and apparatus for producing a coupon in response to a television shopping order disclosed in Japanese Patent No. 3010313 (hereinafter referred to as a second conventional art), a coupon issuing system disclosed in Japanese Unexamined Patent Application Publication 10312415 (hereinafter referred to as a third conventional art), and a coupon and a data collection system using the coupon disclosed in Japanese Utility Model No. 3021952 (hereinafter referred to as a fourth conventional art).

In the first conventional art, a coupon is printed through a POS terminal when the purchase score of a customer exceeds a threshold.

In the second conventional art, a CATV sends coupon information to a user to print out a coupon on a user's printer. The coupon information is embedded in signals of commercials and TV programs. A CATV subscriber unit extracts the coupon information from signals.

In the third conventional art, the system issues a coupon through an electronic P.O. box given to a member and connected through a communication line. The system includes a member DB storing member information containing member attribute information. The system inputs applicant selection criteria for selecting applicants requesting issues of the coupon, selects applicants passing the applicant selection criteria, based on the member information, places, in the electronic P.O. box of the selected member, guidance information for guiding to the issue of the coupon, and issues a coupon when the request to issue the coupon is made in accordance with the guidance information.

In the fourth conventional art, a bar code bearing a distribution area is written on a distributed coupon, and a store learns a user who uses the coupon there.

Known as apparatuses for providing advertisement information are an automatic advertisement delivery system disclosed in Japanese Unexamined Patent Application Publication No. 2000-57157 (hereinafter referred to as a fifth conventional art), a computer system and a karaoke system disclosed in Japanese Unexamined Patent Application Publication No. 09-251296 (hereinafter referred to as a sixth conventional art), and an electronic newspaper system disclosed in Japanese Unexamined Patent Application Publication No. 09-50441 (hereinafter referred to as a seventh conventional art).

In the fifth conventional art, a WWW (World Wide Web) server includes reply-to-request means for replying to a request from a user, and user attribute collection means for collecting user attributes from the data required to respond to the user request. The user attributes collected by the WWW server are stored in user attribute storage means, a single advertisement is selected by advertisement selecting means referring to the collected user attributes, and advertisement delivery means generates, from the selected advertisement, data in a data format to be displayed on a data input/output device, and delivers the data.

In the sixth conventional art, an attribute code representing an overall image of a user is generated based on personal information of a user (namely, attribute data including the age, the sex, the occupation, and the hobby of the user), and a customer image table is created. Based on the content in the customer image table and service history information contained in the personal information, a schedule table for determining a broadcast schedule of spot commercials in a karaoke system is produced. A menu structure table for determining a menu structure of interactive commercials is also produced. The service history is recorded to be reflected in a next service.

In the seventh conventional art, a terminal returns, to a data base, an article request including an article ID as an identifier of a desired article. The data base transmits, to the terminal, a response to the article request, composed of article information that is data of an article identified by the article ID in the article request, and advertisement information that is data describing an advertisement. The terminal displays the article information and the advertisement information in the response to the article request simultaneously on a screen.

Known as a system for providing a digital content such as news is an electronic newspaper system for individuals disclosed in Japanese Unexamined Patent Application Publication No. 4-192751 (hereinafter referred to as an eighth conventional art). Known as a technique related to providing a digital content is a mail order catalog production system disclosed in Japanese Unexamined Patent Application Publication No. 7-200701 (hereinafter referred to as a ninth conventional art).

In the eighth conventional art, the electronic newspaper system receives the article information transmitted from an article information data base storing the article information of newspaper articles, and reorganizes the article information and presents the reorganized article on a screen. The electronic newspaper system includes an information storage unit for storing interests and knowledge of a plurality of individuals as individual page layout information, a learning unit for learning the individual page layout information for the plurality of individuals from the history of search performed by a user, a display control unit which controls a screen to acquire article information for the user from a data base, based on the individual page layout information for the individuals, and to reorganize and display the article information, and a management unit for managing the information storage unit, the learning unit, and the screen control unit.

In this way, the article information in accordance with the interests and knowledge of each user is easily obtained, and more detailed article is thus presented.

Prepared in the ninth conventional art are a product information file holding product information (photographs and illustrations of products, and the description of the products) to be stated in a catalog for each product, a customer information file holding customer information relating to particular attributes of each customer, and a product criterion file that sets, to each product, a criterion which matches each attribute of the customer information. A listed product extraction unit compares the customer information in the customer information file with the criterion in the product criterion file, and extracts only the products that match the criterion of each customer. A layout processing unit reads and lays out product information of extracted products. An electronic color printer prints out the product information on a sheet of paper. The sheets are book-bound into a booklet, which is then sent to individual customers.

A catalog unique to each customer having information about only the products matching the customer's preference is thus produced.

In any of the first through fourth conventional arts, an issuer issues coupon information (a coupon in the form of electronic information) for a commodity or service which the issuer wishes a user to purchase, or issues for a commodity or service which the issuer considers as needed by a user based on personal information. The commodity or service is not necessarily needed by the user. Specifically, the issued coupon information may be really needed by one user, while in many cases the issued coupon information may not be needed by the same user. For example, one user may like watching a baseball game, while he prefers playing golf to playing baseball when actually enjoying sports. The coupon information for the golf gear serves such a user better than the coupon information for the baseball gear.

In each of the fifth through seventh conventional arts, a provider provides advertisement information for a commodity or service which the provider wishes a user to purchase, or provides advertisement information for a commodity or service which the issuer considers as needed by a user based on personal information. The commodity or service is not necessarily needed by the user. Specifically, the advertisement information may be really needed by one user, while in many cases the advertisement information may not be needed by the same user. For example, the advertisement information for the golf gear serves the above-mentioned user better than the advertisement information for the baseball gear.

Most of article information delivered by a digital content delivery system typically includes text information like article information delivered in an electronic mail form. This is because a vast amount of data cannot be transmitted within an available time due to a slow data rate of transmission over a network. For this reason, in many cases, it suffices to read aarticle information on a screen, and there is no much need for printing out the article information. Even if the article information is printed out, a user simply reads a text portion, not very much concerned with the layout thereof. Since the data rate over a network is increasing currently, not only text information but also picture information can also be delivered. When reading the article information on a screen, users experience difficulty to come to grips with the entire article information, and thus possibly desire to see the delivered article information on a printed sheet.

In the eighth conventional art, a WWW browser may be used to read the article information. With the WWW browser, if the article information displayed on screen is printed, a single piece of article information may be printed straddling a plurality of sheets, rather than on a single sheet, and a user may experience difficulty to see printout results. Particularly when a single piece of article information is composed of a picture and text information, the picture may be printed on a sheet different from a sheet on which the text information is printed. In such a case, the user has difficulty in coming to grips with the correspondence between the text information and the picture. The user can be thus unable to understand not only the article information as a whole, but also the contents of individual pieces of article information.

In the digital content delivery system of the ninth conventional art, the above problem is resolved to some degree when the product information of an extracted product is read and laid out. However, the output layout of the catalog is determined by the provider of the catalog. The catalog is printed out in a predetermined output layout which appears for a user easy to see. Although the catalog is easy to see on the average, not all users find it easy to see. Specifically, one user may find the text information printed in a large font easy to see, while another user may find, easy to see, a catalog in which a layout portion assigned to text information is set to be smaller while a layout portion assigned to a picture is set to be larger.

The present invention has been developed to resolve the unresolved problems in the conventional art, and it is an object of the present invention to provide a coupon information issuing system, an advertisement information issuing system, and a storage medium, appropriate for issuing coupon information and advertisement information much needed by the user. It is also another object of the present invention to provide a digital content delivery system which issues the coupon information and the advertisement information, much needed by a user and delivers a digital content in an easy-to-see layout to the user.

### SUMMARY OF THE INVENTION

To achieve the above object, a bonus information issuing system of the present invention as recited in claim 1, for issuing bonus information for gaining a bonus or bonus information itself serving as a bonus, includes user information storage means for storing user information containing information designated by a user, bonus information production means for producing the bonus information based on the user-designated information in the user information storage means, and bonus information issuing means for issuing, to the user, the bonus information produced by the bonus information production means.

In this arrangement, to issue the bonus information, the bonus information production means produces the bonus information based on the user-designated information in the user information storage means, and the bonus information issuing means issues, to the user, the bonus information produced by the bonus information production means.

The user information storage means stores the user information by any means and at any time. The user information storage means may store beforehand the user information, or may store the user information in response to inputting from the outside at the startup of the system without storing beforehand the user information. In that sense, the same is true of an advertisement information issuing system according to claim 2, and a digital content delivery system according to any of claims 3, 4, and 5.

The system may be implemented in a single apparatus, or may be implemented in a network system to which a plurality of terminals are communicably connected. The same is true of the advertisement information issuing system according to claim 2, and the digital content delivery system according to any of claims 3, 4, and 5.

The issue of the bonus information may be performed by delivering the bonus information to the user. Alternatively, the bonus information may be stored in a storage means in a terminal to which a user terminal is communicable, and the user accesses the terminal to gain the bonus information using the user terminal.

To achieve the above object, an advertisement information issuing system of the present invention as recited in claim 2 for issuing advertisement information for an advertisement, includes user information storage means for storing user information containing information designated by a user, advertisement information production means for producing the advertisement information based on the user-designated information in the user information storage means, and advertisement information issuing means for issuing, to the user, the advertisement information produced by the advertisement information production means.

In this arrangement, to deliver the advertisement information, the advertisement information production means produces the advertisement information based on the user-designated information in the user information storage means, and the advertisement information issuing means issues, to the user, the advertisement information produced by the advertisement information production means.

The issue of the advertisement information may be performed by delivering the advertisement information to the user. Alternatively, the advertisement information may be stored in a storage means in a terminal to which a user terminal is communicable, and the user accesses the terminal to gain the advertisement information using the user terminal.

To achieve the above-referenced object, a digital content delivery system of the present invention as recited in claim 3 for delivering a digital content, includes user information storage means for storing user information containing information designated by a user, bonus information production means for producing bonus information for gaining a bonus or bonus information itself serving as a bonus, based on the user-designated information in the user information storage means, bonus information association means for associating the bonus information produced by the bonus information production means with the digital content so that the bonus information is gained, and content delivery means for delivering, to the user, the digital content with which the bonus information is associated by the bonus information association means.

To deliver the digital content with the bonus information in this arrangement, the bonus information production means produces the bonus information based on the user-designated information in the user information storage means, the bonus information association means associates the produced bonus information with the digital content so that the bonus information is gained, and the content delivery means delivers, to the user, the digital content with which the bonus information is associated.

The bonus information is associated with the digital content. The association of the bonus information with the digital content may be performed by adding the bonus information to the digital content, or may be performed by adding, to the digital content, reference information (such as a URL (Uniform Resource Locator)) by which the bonus information is retrieved. The same is true of a digital content delivery system of claim 5.

A digital content delivery system of the present invention as recited in claim 4 for delivering a digital content, includes user information storage means for storing user information containing information designated by a user, advertisement information production means for producing advertisement information for an advertisement, based on the user-designated information in the user information storage means, advertisement information association means for associating the advertisement information produced by the advertisement information production means with the digital content so that the advertisement information is read, and content delivery means for delivering, to the user, the digital content with which the advertisement information is associated by the advertisement information association means.

To deliver the digital content with the advertisement information in this arrangement, the advertisement information production means produces the advertisement information based on the user-designated information in the user information storage means, the advertisement information association means associates the produced advertisement information with the digital content so that the advertisement information is read, and the content delivery means delivers the digital content with which the advertisement information is associated.

The advertisement information is required to be associated with the digital content. The association of the advertisement information with the digital content may be performed by adding the advertisement information to the digital content, or may be performed by adding, to the digital content, reference information (such as a URL) by which the advertisement information is retrieved. The same is true of the digital content delivery system of claim 5.

A digital content delivery system of the present invention as recited in claim 5 for delivering a digital content, includes user information storage means for storing user information containing information designated by a user, bonus information production means for producing bonus information for gaining a bonus or bonus information itself serving as a bonus, based on the user-designated information in the user information storage means, advertisement information production means for producing advertisement information for an advertisement based on the user-designated information in the user information storage means, content layout means for laying out the digital content after determining an output layout of the digital content based on the user-designated information in the user information storage means, bonus information association means for associating the bonus information produced by the bonus information production means with the digital content laid out by the content layout means so that the bonus information is gained, advertisement information association means for associating the advertisement information produced by the advertisement information production means with the digital content laid out by the content layout means so that the advertisement information is read, and content delivery means for delivering, to the user, the digital content with which the bonus information and the advertisement information are associated respectively by the bonus information association means and the advertisement information association means.

In this arrangement, to deliver the digital content with which the bonus information and the advertisement information are associated, the bonus information production means produces the bonus information, based on the user-designated information in the user information storage means, the advertisement information production means produces the advertisement information based on the user-designated information in the user information storage means, and the content layout means lays out the digital content after determining an output layout of the digital content based on the user-designated information in the user information storage means. The bonus information association means associates the bonus information produced by the bonus information production means with the digital content laid out by the content layout means so that the bonus information is gained, the advertisement information association means associates the advertisement information produced by the advertisement production means with the digital content laid out by the content layout means so that the advertisement information is read, and the content delivery means delivers, to the user, the digital content with which the bonus information and the advertisement information are associated respectively by the bonus information association means and the advertisement information association means.

The output layout includes a display layout according to which the digital content is displayed on a screen, and a print layout according to which the digital content is printed on a sheet of paper.

The user-designated information used to produce the bonus information, the user-designated information used to produce the advertisement information, and the designate information used to produce the output layout may be the same information, or may be different pieces of information. These pieces of user-designated information are preferably different from each other from the standpoint of providing the user with the bonus information and the advertisement information much needed by the user.

A digital content delivery system of the present invention as recited in claim 6, according to claim 5, further includes content storage means for storing a plurality of digital contents, and content selecting means for selecting the digital content in the content storage means based on the user-designated information in the user storage means, wherein the content layout means lays out the digital content based on the user-designated information in the user information storage means after determining an output layout of the digital content that is selected by the content selecting means.

In this arrangement, the content selecting means selects the digital content in the content storage means based on the user-designated information in the user information storage means, and the content layout means lays out the digital content based on the user-designated information in the user information storage means after determining the output layout of the digital content that is selected by the content selecting means.

The user-designated information used to select the digital content and the user-designated information used to determine the output layout may be the same information, or may be different pieces of information. These pieces of user-designated information are preferably different from each other from the standpoint of outputting the digital content in an easy-to-see output layout to the user.

A digital content delivery system of the present invention as recited in claim 7, according to one of claims 5 and 6, the bonus information production means produces the bonus information by the number of times equal to the number of deliveries of the digital content.

In this arrangement, the bonus information production means produces the bonus information by the number of times equal to the number of deliveries of the digital content.

A digital content delivery system of the present invention as recited in claim 8, according to one of claims 5 through 7, the user information contains preference information relating to the interest of the user's or the preference of the user's, the bonus information production means produces the bonus information matching the user's interest or preference based on the preference information in the user information storage means, and the advertisement information production means produces the advertisement information matching the user's interest or preference based on the preference information in the user information storage means.

In this arrangement, the bonus information production means produces the bonus information matching the user's interest or preference based on the preference information in the user information storage means, and the advertisement information production means produces the advertisement information matching the user's interest or preference based on the preference information in the user information storage means.

A digital content delivery system of the present invention as recited in claim 9, according to one of claims 5 through 8, the user information contains area information relating to a local area desired by the user, the bonus information production means produces the bonus information to gain a bonus within the user-desired local area based on the area information in the user information storage means, and the advertisement information production means produces the advertisement information relating to the user-desired local area based on the area information in the user information storage means.

In this arrangement, the bonus information production means produces the bonus information to gain the bonus within the user-desired local area based on the area information in the user information storage means, and the advertisement information production means produces the advertisement information relating to the user-desired local area based on the area information in the user information storage means.

A digital content delivery system of the present invention as recited in claim 10, according to one of claims 5 through 9, the user information contains period information relating to a period desired by the user, the bonus information production means produces the bonus information to gain a bonus within a predetermined period starting from the present moment based on the period information in the user information storage means, and the advertisement information production means produces useful advertisement information within a predetermined period starting from the present moment based on the period information in the user information storage means.

In this arrangement, the bonus information production means produces the bonus information to gain a bonus within a predetermined period starting from the present moment based on the period information in the user information storage means, and the advertisement information production means produces the useful advertisement information within a predetermined period starting from the present moment based on the period information in the user information storage means.

Although a specific data structure of the user-designated information has not been discussed in connection with the bonus information issuing system of claim 1, the advertisement information issuing system of claim 2, and the digital content delivery system of each of claim 3 through claim 11, the following data structure may be contemplated.

First, the user-designated information is the one that can designate a provider of the bonus information or the advertisement information. The user thus gains the bonus information or the advertisement information about the user-designated provider.

Second, the user-designated information is the one that can designate a category of a commodity or service for which the bonus information or the advertisement information is issued. The user in this way can gain the bonus information or the advertisement information about the commodity or service of designated category.

Third, the user-designated information is the one that can designate a local area within which the use of the bonus information is desired, or can designate an advertisement area of the advertisement information. The user can thus gain the bonus information usable within the designated area or the advertisement information relating to the designated area.

Fourth, the user-designated information is the one that can designate the period within which the use of the bonus information is desired or can designate the advertisement time of the advertisement information. In this way, the user can gain the bonus information that can be used within the designated period or the advertisement information relating to the designated time.

Fifth, the user-designated information is the one that can designate the score of bonus obtained from the bonus information. In this way, the user gains the bonus information of the designated score.

Sixth, the user-designated information is the one that can designate the position at which the bonus information or the advertisement information relating to the output layout of the digital content is located. In this way, the user receives the digital content in which the bonus information or the advertisement information is located at the designated position.

Seventh, the user-designated information is the one that can designate the layout position, the size, the color, and the definition of the digital content, the quality of the digital content such as a definition, and the gradation levels of the digital content. The user thus receives the digital content at the designated position, for example.

Eighth, the user-designated information is the one that can designate the output layout of the digital content such as a print layout or a display layout. The user thus receives the digital content at the set print layout or the set display layout.

A digital content delivery system of the present invention as recited in claim 11, according to one of claims 5 through 10, the user information contains schedule information relating to a schedule of the user, the bonus information production means produces the bonus information appropriate for the schedule of the user based on the schedule information in the user information storage means, and the advertisement information production means produces the advertisement information appropriate for the schedule of the user based on the schedule information in the user information storage means.

To achieve the above-referenced object, a storage medium of the present invention as recited in claim 12 stores a computer readable bonus issuing software program for issuing bonus information for gaining a bonus or bonus information itself serving as a bonus, wherein in a computer comprising user information storage means for storing user information containing information designated by a user, the software program controls the process to be carried out by bonus information production means for producing the bonus information based on the user-designated information in the user information storage means, and by bonus information issuing means for issuing, to the user, the bonus information produced by the bonus information production means.

In this arrangement, the computer reads the bonus information issuing software program from the storage medium, and performs processes in accordance with the read program. The storage medium thus provides the same advantages as those of the bonus information issuing system as recited in claim 1.

To achieve the above-referenced object, a storage medium of the present invention as recited in claim 13 stores a computer readable advertisement information issuing software program for issuing advertisement information relating to an advertisement, wherein in a computer comprising user information storage means for storing user information containing information designated by a user, the software program controls a process to be carried out by advertisement information production means for producing the advertisement information based on the user-designated information in the user information storage means, and by advertisement information issuing means for issuing, to the user, the advertisement information produced by the advertisement information production means.

In this arrangement, the computer reads the advertisement information issuing software program from the storage medium, and performs processes in accordance with the read program. The storage medium thus provides the same advantages as those of the advertisement information issuing system as recited in claim 2.

To achieve the above-referenced object, the bonus information issuing system, the advertisement information issuing system, the digital content delivery system, and the storage medium have been proposed. The present invention is not limited to these, and the following storage medium is contemplated to achieve the above-referenced object.

A storage medium storing a computer readable digital content delivery program for delivering a digital content, wherein in a computer including user information storage means for storing user information containing information designated by a user, the digital content delivery software program controls a process to be carried out by bonus information production means for producing bonus information for gaining a bonus or bonus information itself serving as a bonus, based on the user-designated information in the user information storage means, advertisement information production means for producing advertisement information relating to an advertisement based on the user-designated information in the user information storage means, content layout means for laying out the digital content after determining an output layout of the digital content based on the user-designated information in the user information storage means, bonus information association means for associating the bonus information produced by the bonus information production means with the digital content laid out by the content layout means so that the bonus information is gained, advertisement information association means for associating the advertisement information produced by the advertisement production means with the digital content laid out by the content layout means so that the advertisement information is read, and content delivery means for delivering, to the user, the digital content with which the bonus information and the advertisement information are associated respectively by the bonus information association means and the advertisement information association means.

In this arrangement, the computer reads the digital content delivery program from the storage medium, and performs processes in accordance with the read program. The storage medium thus provides the same advantages as those of the digital content delivery system as recited in claim 5.

### BRIEF DESCRIPTION OF THE DRAWINGS

FIG. 1 is a block diagram showing the construction of a network system to implement the present invention.

FIG. 2 is a block diagram showing the construction of a content delivery terminal 100.

FIG. 3 shows a data structure of a user profile table 300.

FIG. 4 shows a data structure of a layout definition file and a data structure of a layout number definition table 330.

FIG. 5 shows a digital content and a data structure of a category number definition table 340.

FIG. 6 shows a data structure of bonus information registration DB 44.

FIG. 7 is a flow diagram showing a user registration process.

FIG. 8 is a flow diagram showing a content delivery process.

FIG. 9 shows a user ID entry screen.

FIG. 10 shows a category entry screen.

FIG. 11 shows an output layout entry screen.

FIG. 12 shows a registration content verification screen.

### DETAILED DESCRIPTION OF PREFERRED EMBODIMENTS

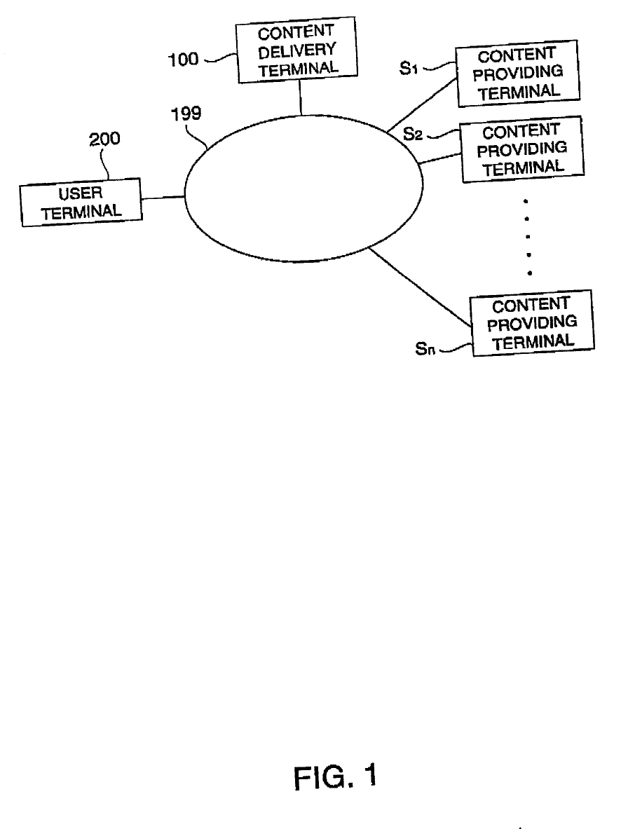

Referring to the drawings, the embodiments of the present invention will now be discussed, referring to the drawings. FIG. 1 through FIG. 12 show embodiments of a bonus information issuing system, an advertisement information issuing system, a digital content delivery system, and a storage medium of the present system.

As shown in FIG. 1, the bonus information issuing system, the advertisement information issuing system, the digital content delivery system, and the storage medium of the present invention are applied in a system in which a content delivery terminal 100 delivers digital contents such as news to a user terminal 200.

The construction of a network system implementing the present invention will now be discussed, referring to FIG. 1. FIG. 1 is a block diagram showing the construction of the network system implementing the present invention.

Connected to the Internet 199 as shown in FIG. 1 are a plurality of content providing terminals S₁-Sₙ for providing digital contents, a content delivery terminal 100 which collects digital contents supplied from the content providing terminals S₁-Sₙ and then delivers the digital contents, and a user terminal 200 used by a user. For simplicity, a single user terminal 200 is connected as shown, but a plurality of user terminals are connected to the Internet 199 in practice.

Each of the content providing terminals S₁-Sₙ, having the same function of a typically available computer, is composed of a CPU, an ROM, an RAM, and an I/F, all of these interconnected through a bus. When the content providing terminal produces a digital content, a category number is added to the digital content to identify the category thereof, and transmits the digital content to the content delivery terminal 100. The category number will be discussed in detail later.

The user terminal 200, having the same function of a typically available computer, is composed of a CPU, an ROM, an RAM, and an I/F, all of these interconnected through a bus. The user terminal 200 is also equipped with a WWW browser, and accesses the content delivery terminal 100 using the WWW browser.

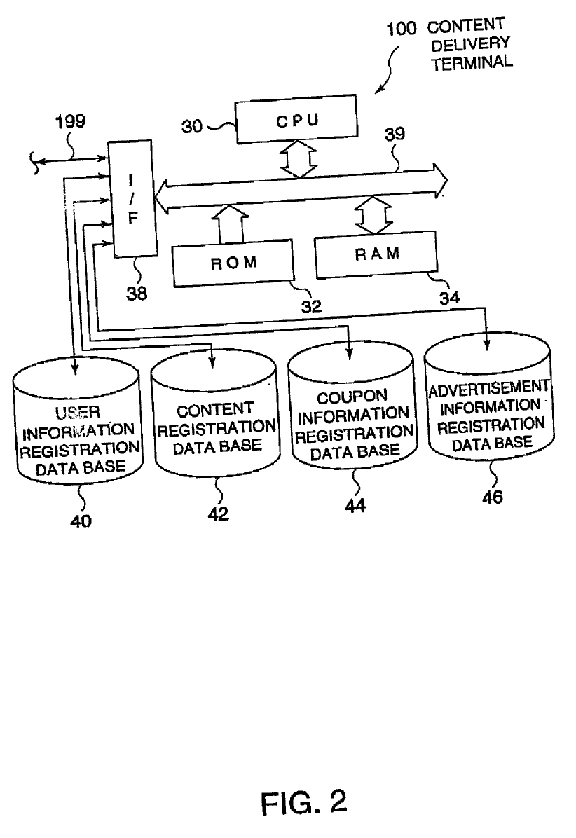

The construction of the content delivery terminal 100 will now be discussed in detail, referring to FIG. 2. FIG. 2 is a block diagram showing the construction of the content delivery terminal 100.

Referring to FIG. 2, the content delivery terminal 100 includes a CPU 30 for performing arithmetic operation and controlling the entire system, an ROM 32 for storing beforehand a control program of the CPU 30 in a predetermined area thereof, an RAM 34 for storing data read from the ROM 32 or the like and calculation results required in the course of the arithmetic operation of the CPU 30, and an I/F 38 for interfacing with an external device for exchange of data. To exchange data, these components are mutually interconnected via a bus 39, as a signal line for transferring data.

Connected to the I/F 38 are, as external units, a user information registration data base (the term data base hereinafter simply referred to as “DB”) 40 for registering user information, a content registration DB 42, for collecting and storing digital contents supplied by the content providing terminals S₁-Sₙ, a coupon information registration DB 44 for registering the coupon information relating to a coupon that is issued to the user together with a digital content, an advertisement information registration DB 46 for registering advertisement information relating to an advertisement that is supplied to a user together with the digital content, and a signal line connected to the Internet 199.

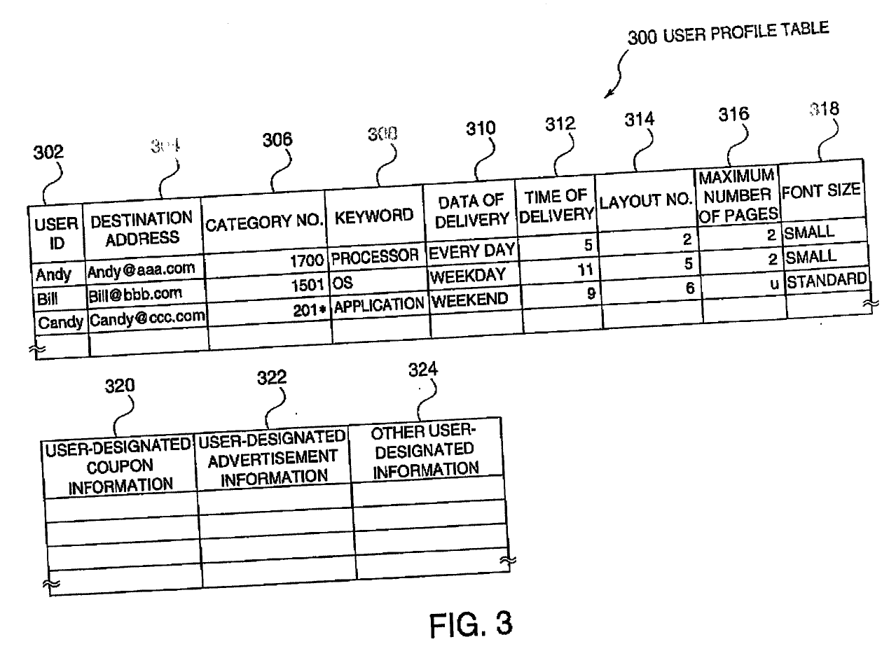

Referring to FIG. 3, the user information registration DB 40 stores a user profile table 300 in which the user information is registered. FIG. 3 shows a data structure of the user profile table 300.

The user profile table 300 registers a single or a plurality of records for each user as shown in FIG. 3. Each record includes a field 302 for registering a user ID for identifying a user, a field 304 for registering a destination address of a digital content, a field 306 for registering a category number, a field 308 for registering a keyword, a field 310 for registering a date of delivery, a field 312 for registering time of delivery, a field 314 for registering a layout number, a field 316 for registering a maximum number of pages, a field 318 for registering a font size, a field 320 for registering user-designated coupon information designated by the user when the coupon is issued, a field 322 for registering user-designated advertisement information designated by the user when an advertisement is provided, and a field 324 for registering other user-designated information.

When a digital content containing a keyword designated by a user is selected as data to be delivered, the field 308 registers that keyword. The keyword may be the one that appears mostly frequently in the news of a category in which the user is interested. Referring to FIG. 3, a “PROCESSOR” is registered in a first row of the field 308, and an “OS” is registered in a second row of the field 308.

The field 310 registers a date of delivery on which the user desires the delivery of the digital content. For example, when the delivery of the digital content is desired every day, “EVERYDAY” is designated. When the delivery of the digital content is desired on a weekday only, a “WEEKDAY” is designated. When the delivery of the digital content is desired on a weekend, a “WEEKEND” is designated. Referring to FIG. 3, “EVERYDAY” is registered in a first row of the field 310, and a “WEEKDAY” is registered in a second row of the field 310.

The field 312 registers the time of delivery of the digital content on the delivery date designated by the user. As the time of delivery, one day may be divided into 24 hours from zero hour band to twenty-third hour band, and any time band may be designated. Referring to FIG. 3, a fifth hour band is registered in a first row of the field 312, and an eleventh hour band is registered in a second row in the field 312.

The field 314 registers the layout number for identifying the output layout of the digital content. The layout number identifies the output layout desired by the user. Referring to FIG. 3, layout number 2 is registered in a first row of the field 314, and layout number 5 is registered in a second row of the field 314. The layout number will be discussed in detail later.

The field 316 registers the maximum number of pages at the upper limit when the digital content is displayed or printed out. The maximum number of pages designates the maximum numbers of pages at the upper limit. Alternatively, the letter “u” may be designated to set no upper limit. Referring to FIG. 3, “2” pages are registered in a first row of the field 316, and the letter “u” is registered in a third row of the field 316.

The field 318 registers the size of a font when the digital content is displayed or printed out. Referring to FIG. 3, a “SMALL” font is registered in a first row of the field 318, and a “STANDARD” font is registered in a third row of the field 318.

The field 320 registers the user-designated coupon information designated by the user when the coupon is issued. The user-designated coupon information may relate to the user's interest or preference and may be category information that represents a category of a commodity or service for which a coupon is issued, may be area information representing an area within which the user wishes to use the coupon information, may be period information indicating a period within which the use of the coupon information is desired, or may be schedule information relating to the schedule of the user.

The category information designates the field of the user's interest or preference. When the user designates this item, the coupon information about a commodity or service in the field of the user's interest or the field of the user's preference is issued for the user.

The area information designates a location where the user lives, or an area within which the use of the coupon information is desired. When the user designates this item, the coupon information, which is usable at the location where the user lives, or in the area within which the use of the coupon information is desired, is issued to the user.

The period information designates the time at which the user desires to use the coupon information or the period within which the user desires to use the coupon information. For example, when the user wants service at the end of July, the period information designates the end of July. The user designates this item, and the coupon information, which is usable at the time designated by the user or within the period designated by the user, is issued to the user.

The schedule information designates the schedule of the user. For example, when a user plans to make a business trip to Tokyo next week, he may desire coupon information that may be used there within that period. When the user designates this item, the coupon information usable in Tokyo next week is issued to the user.

The field 322 registers the user-designated advertisement information, designated by the user when an advertisement is issued. The user-designated advertisement information may relate to the user's interest or preference and may be category information that represents a category of a commodity or service for which advertisement information is issued, may be area information representing an advertisement area of the advertisement information, may be period information indicating an advertisement period of the advertisement information, or may be schedule information relating to the schedule of the user.

The category information designates the field of the user's interest or preference. When the user designates this item, the advertisement information about a commodity or service in the field of the user's interest or the field of the user's preference is issued to the user. The category information of the user-designated advertisement information and the category information of the user-designated coupon information may be the same. Since there are cases where the coupon information and the advertisement information desired by the user are different to each other, it is preferred that these pieces of information are independently set. The same is true of the area information and the period information.

The area information designates a location where the user lives, or an area within which the use of the advertisement information is desired. When the user designates this item, the advertisement information, which is usable at the location where the user lives, or in the area within which the use of the advertisement information is desired, is issued to the user.

The user designates the advertisement time or the advertisement period by the period information. For example, when the user wants service at the end of July, the period information designates the end of July. When the user designates this item, the advertisement information useful at the advertisement time or within the advertisement period is provided to the user.

The schedule information designates the schedule of the user. For example, when a user plans to make a business trip to Tokyo next week, he may desire advertisement information that may be useful for him there at that period. When the user designates this item, the advertisement information usable in Tokyo next week is issued to the user.

The field 324 registers information designated by the user, namely other user-designated information other than information registered in fields 302-322. For example, the other user-designated information may include a data size and data reception time, the quality of a digital content (of whether the content is monochrome or color, or DPI of the digital content), a ratio of text information to pictures, the type of information located in space left after the digital content is arranged (photographs, advertisements, and a list of recommended articles), the type and color of a font, a character pitch, a line pitch, and a sheet size of printing sheets, when the digital content is received.

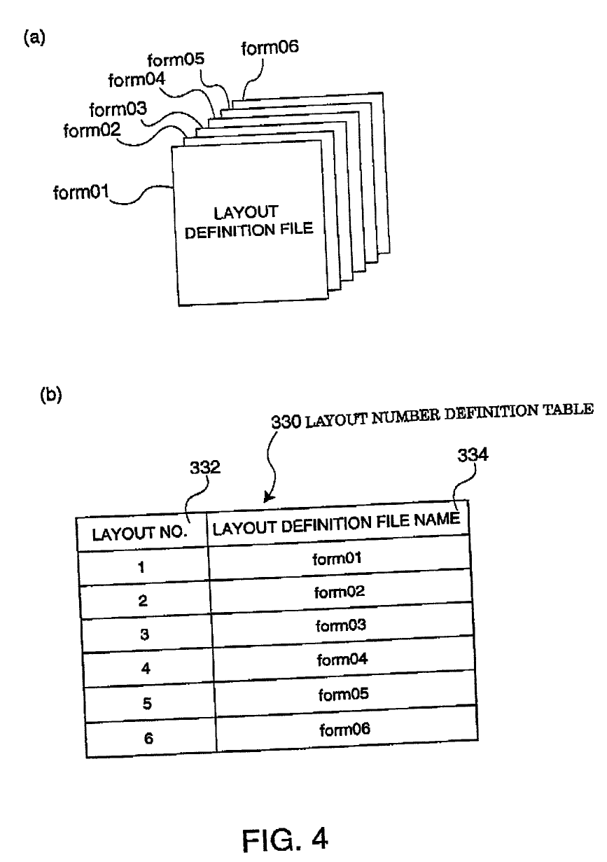

Referring to FIG. 4, the user information registration DB 40 stores a plurality of layout definition files form01-form06 defining the output layout of the digital contents, and a layout number definition table 330 for indicating the correspondence between the layout definition files form01-form06 and the layout numbers. FIG. 4 shows the layout definition file and a data structure of the layout number definition table 330.

The layout definition files form01-form06 define a text information box for accommodating text information, the size of a picture contained in the digital content, a layout position in a printing sheet, the size, the type and color of a font of the text information, a character pitch and a line pitch, and the number of, the quality of, and the ratio of pictures. The layout definition files are defined by the XML (eXtensible Markup Language).

Referring to FIG. 4(b), the layout number definition table 330 registers a single record for each layout number. Each record includes a field 332 for registering the layout number, and a field 334 for registering a file name of the layout definition file. As shown in FIG. 4(b), a first record registers “I ”as a layout number, and “form01” as a layout definition file name, and a second record register “2” as a layout number, and “form02” as a layout definition file name.

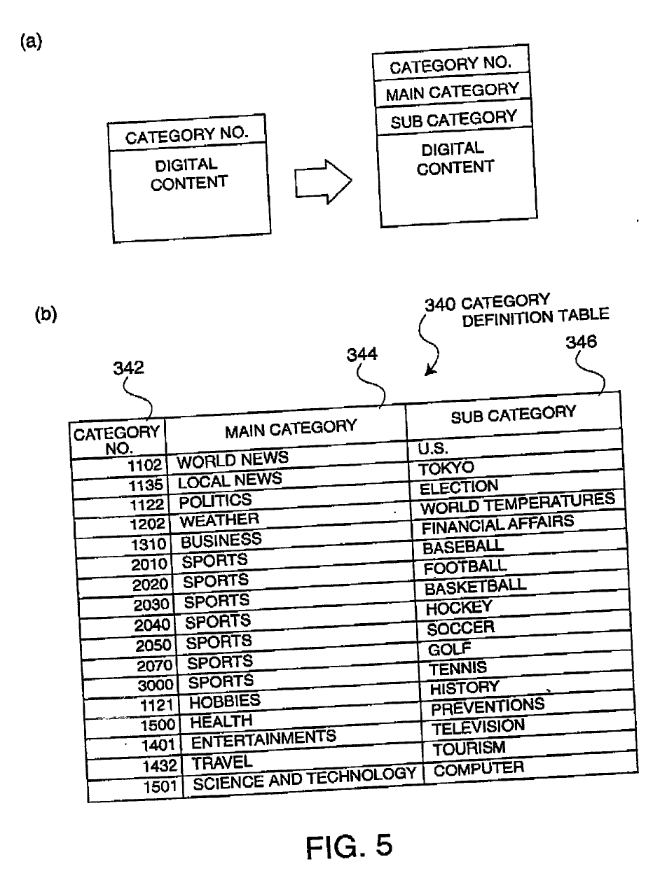

Referring to FIG. 5, the content registration DB 42 stores a category number definition table 340 that shows the relationship between the digital contents supplied from the content providing terminals S₁-Sₙ, the main category, the subcategory, and the category number. FIG. 5 shows the digital contents and the data structure of the category number definition table 340.

As shown in FIG. 5(a), the digital contents supplied by the content providing terminals S₁-Sₙ are tagged with the respective category numbers, and the content delivery terminal 100 classifies the digital contents using the category number by category, and registers the classified digital contents in the content registration DB 42. When registering, the content delivery terminal 100 references the category number definition table 340, and adds the category number, the main category, and the subcategory to the digital contents.

Referring to FIG. 5(b), the category number definition table 340 registers a single record in each of the main category and the subcategory. Each record includes a field 342 for registering a category number, a field 344 for registering a main category, and a field 346 for registering a subcategory. As shown in FIG. 5(b), a first row record registers “1102” as the category number, “WORLD NEWS” as the main category, and “U.S.” as the subcategory, and a sixth row record registers “2010” as the category number, “SPORTS” as the main category, and “BASEBALL” as the subcategory.

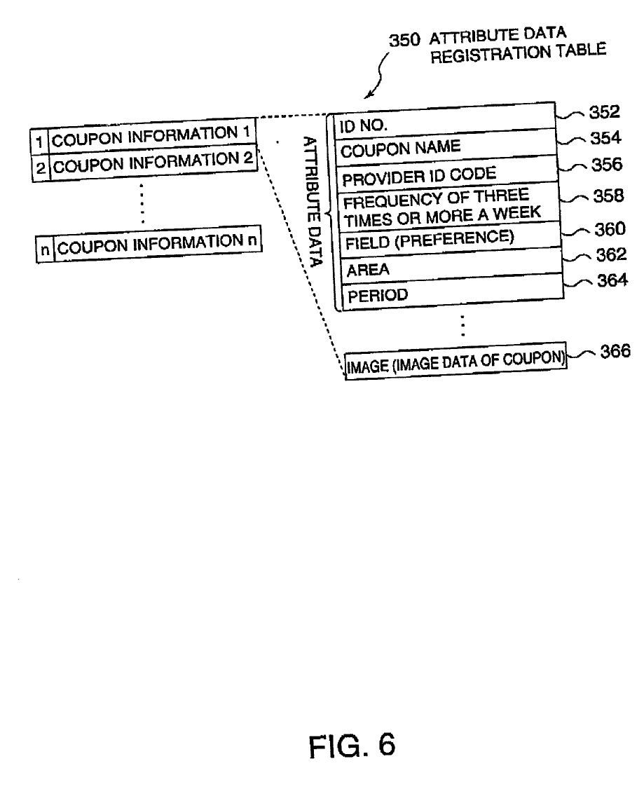

Referring to FIG. 6, the coupon information registration DB 44 stores a attribute data registration table 350 for registering attribute data, relating to attributes, out of the coupon information, and image data showing the image of a coupon out of the coupon information. FIG. 6 shows the data structure of the coupon information registration DB 44.

Referring to FIG. 6, the attribute data registration table 350 registers a single record for each piece of coupon information. Each record is composed of a field 352 for registering an ID number for identifying the coupon information, a field 354 for registering a coupon name, a field 356 for registering the name of a corporate providing coupon information and an identification code thereof, a field 358 for registering issuing criteria by which the coupon information is issued (for example, a person who receives the digital content three times or more a week), a field 360 for registering the category of a commodity or service for which the coupon information is issued, a field 362 for registering an area within which the coupon information is used, and a field 364 for registering the time at which the coupon information is used. Each record is associated with the image data 366 of the coupon information.

The advertisement information registration DB 46 registers the advertisement information having the same data structure as that of the coupon information registration DB 44, although the data structure of the advertisement information registration DB 46 is not shown.

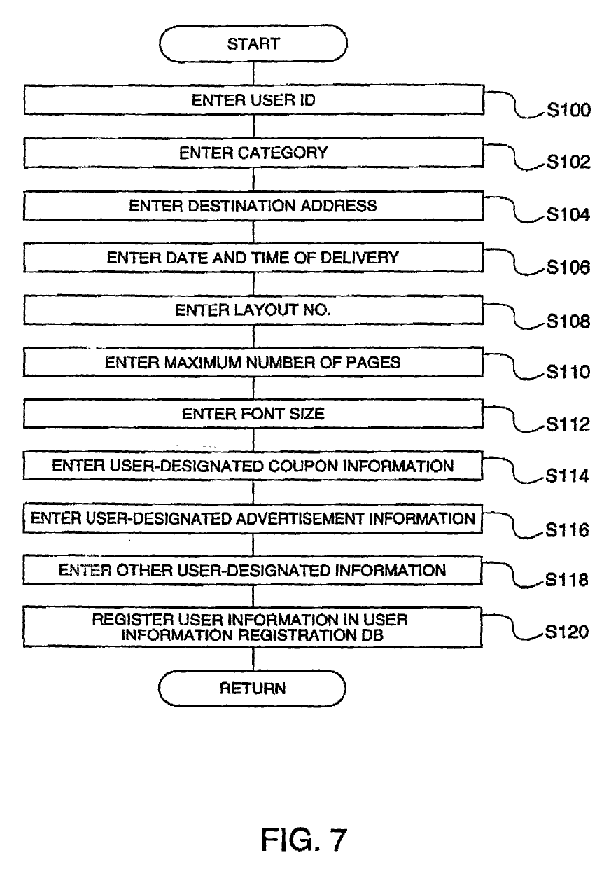

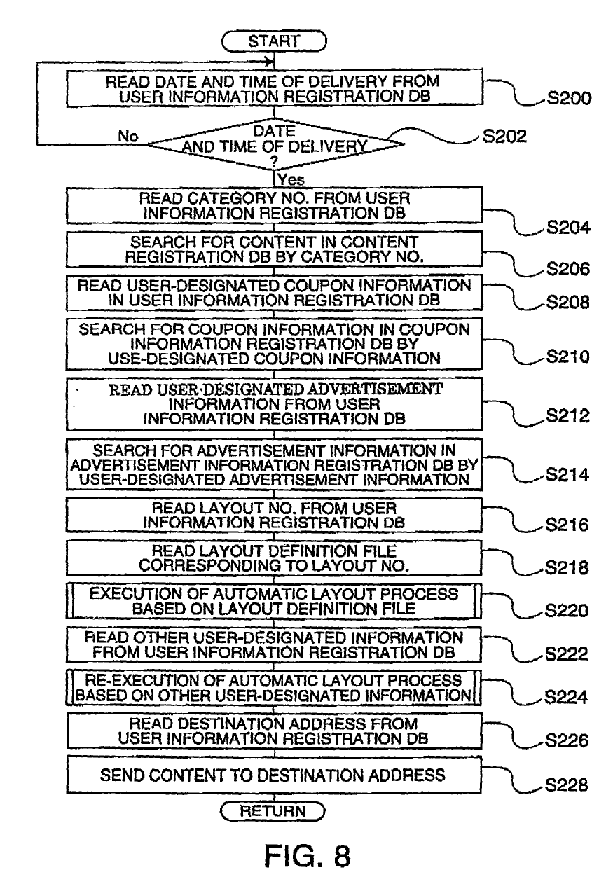

The construction of the CPU 30 and the process executed by the CPU 30 will be discussed referring to FIG. 7 and FIG. 8.

The CPU 30, composed of a micro processing unit (an MPU), starts a predetermined program stored in a predetermined area of the ROM 32, and executes a user registration process and a content delivery process in a time sharing manner as shown in FIG. 7 and FIG. 8.

Referring to FIG. 7, the user registration process will first be discussed in detail. FIG. 7 is a flow diagram showing the user registration process.

When the user has accessed the system, the user registration process requests the user to input the required user information such as the user ID, and registers the input user information in the user profile table 300. When the CPU 30 starts, the process goes to step S100 shown in FIG. 7. An input operation in each of the following steps is performed in an interactive manner.

In step S100, the user ID is input. In step S102, the main category and the sub category are input. In step S104, the destination address is input, and in step S106, the date and time of delivery are input, and the process proceeds to step S108.

In step S108, the layout number is input. In step S110, the maximum number of pages is input. In step S112, the font size is input. The process proceeds to step S114.

In step S114, the user-designated coupon information is input. In step S116, the user-designated advertisement information is input. In step S 118, the other user-designated information is input. In step S120, the user information input in steps S100 through S118 is registered in the user profile table 300, and the process returns.

The content delivery process will now be discussed, referring to FIG. 8. FIG. 8 is a flow diagram showing the content delivery process.

The content delivery process delivers the digital content to the user terminal 200 by referencing the user profile table 300. Referring to FIG. 8, when the CPU 30 starts, the process proceeds to step S200. The process of the following steps is performed for each record of the user profile table 300. In practice, each step is performed by the number of times equal to the number of records registered in the user profile table 300.

In step S200, the date and time of delivery are read from the user profile table 300. In step S202, the CPU 30 determines, from the read date and time of delivery, whether it is the day on which the digital content must be delivered. When the CPU 30 determines that it is the day on which the digital content must be delivered (Yes), the process proceeds to step S204, else (No) the process returns to step S200.

In step S204, the CPU 30 reads the category number from the user profile table 300. In step S206, the CPU 30 searches for the digital content in the content registration DB 42 in accordance with the read category number, and retrieves the digital content having a category number matching the read category number. The process proceeds to step S208.

In step S208, the CPU 30 reads the user-designated coupon information from the user profile table 300. In step S210, the CPU 30 searches for the coupon information in the coupon information registration DB 44 based on the read user-designated coupon information, and retrieves the coupon information matching the user-designated coupon information. Specifically, in step S210, the CPU 30 searches for the attribute data in the attribute data registration table 350 in accordance with the category information, the area information, the period information and the schedule information out of the user-designated coupon information, and identifies the coupon information matching the category information, the area information, the period information and the schedule information. When the user profile satisfies the issuing criteria of the attribute data of the identified coupon information, the coupon information is retrieved.

The searching by the category information is performed by searching for the coupon information matching the user's interest or preference in accordance with the category information. The searching by the area information is performed by searching for the coupon information usable in the area desired by the user in accordance with the area information. The searching by the period information is performed by searching for the coupon information which is usable within a predetermined period of time starting from the present time in accordance with the period information. The searching by the schedule information is performed by searching for the coupon information which is the most appropriate for the schedule of the user in accordance with the schedule information. When the coupon information is searched for, the coupon information, which matches all of the category information, the area information, the period information, and the schedule information, is retrieved. The present invention is not limited to this arrangement. Alternatively, the coupon information is searched for by the category information, the area information, the period information, and the schedule information, and the coupon information that results in the highest degree of match may be retrieved.

In step S212, the CPU 30 reads the user-designated advertisement information from the user profile table 300. In step S214, the CPU 30 searches for the advertisement information in the advertisement information registration DB 46 in accordance with the read user-designated advertisement information, and retrieves the advertisement information matching the user-designated advertisement information. In step S214, the CPU 30 specifically searches for the attribute data in the attribute data registration table (not shown) in accordance with the category information, the area information, the period information, and the schedule information out of the user-designated advertisement information, and retrieves the advertisement information matching the category information, the area information, the period information, and the schedule information.

The searching by the category information is performed by searching for the advertisement information matching the user's interest or preference in accordance with the category information. The searching by the area information is performed by searching for the advertisement information usable in the area desired by the user in accordance with the area information. The searching by the period information is performed by searching for the advertisement information which is usable within a predetermined period of time starting from the present time in accordance with the period information. The searching by the schedule information is performed by searching for the advertisement information which appears the most appropriate for the schedule of the user in accordance with the schedule information. When the advertisement information is searched for, the advertisement information, which matches all of the category information, the area information, the period information, and the schedule information, is retrieved. The present invention is not limited to this arrangement. Alternatively, the advertisement information is searched for by the category information, the area information, the period information, and the schedule information, and the advertisement information that results in the highest degree of match may be retrieved.

In step S216, the CPU 30 reads the layout number from the user profile table 300. In step S218, the CPU 30 references a layout definition table 330, reads the layout definition file corresponding to the read layout number from the user information registration DB 40. In step S220, the CPU 30 performs an automatic layout process in which the output layout of the digital content is determined using the digital content, the coupon information, and the advertisement information respectively retrieved in steps S206, S210, and S214, and the digital content is then laid out. The process then proceeds to step S222.

In step S222, the CPU 30 reads the other user-designated information from the user profile table 300. In step S224, the CPU 30 performs again the automatic layout process in which the output layout of the digital content produced in step S220 is determined again based on the read other user-designated information, and the digital content is laid out.

When the other user-designated information is the data size or the date reception time at the reception of the digital content and when the user designates a data size and data reception time, the CPU 30 determines the picture, the text information and the maximum number of pages in step S224 to respond to the user-designated data size and the data reception time. When the picture, the text information and the maximum number of pages are changed, the layout operation is performed again.

When the other user-designated information is a quality of the digital content input by the user, the picture is determined in accordance with the input quality setting.

When the other user-designated information is the ratio of the text information to the pictures, selected by the user, the picture is selected to the ratio input by the user.

When the other user-designated information is the type of information located in space left after the digital content is arranged and designated by the user, the digital content is selected so that the digital content of that type is inserted.

When the other user-designated information is the type and the color of the font designated by the user, the type and the color of the font are determined accordingly.

When the other user-designated information is the character pitch and the line pitch designated by the user, the layout in the text information box is determined so that the character pitch and the line pitch are set to be as designated.

When the other user-designated information is the printing sheet size designated by the user, such a printing sheet size is used and the output layout is determined. When the other user-designated information is the maximum number of pages designated by the user, the output layout is determined to the designated maximum number of pages.

In step S226, the CPU 30 reads the destination address from the user profile table 300. In step S228, the CPU 30 delivers the produced digital content to the destination address, and the process returns.

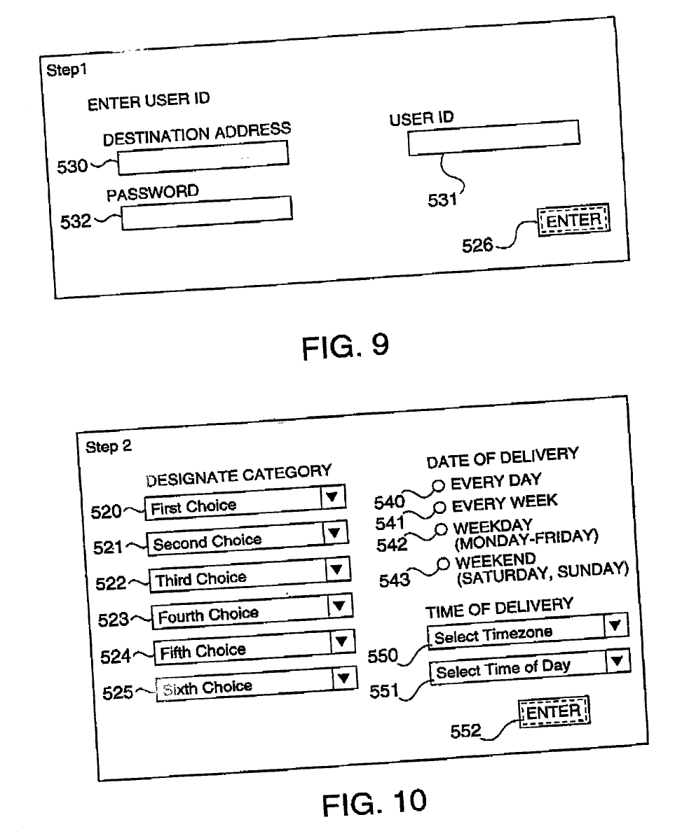

Referring to FIG. 9 through FIG. 12, the operation of the above-referenced embodiment will be discussed.

The registration process for registering information required to deliver the digital content will now be discussed.

When the user desires the delivery of a digital content, the user accesses the content delivery terminal 100 using the WWW browser on the user terminal 200, and inputs a user registration request.

When the user registration request is input, the user terminal 200 receives screen construction data for forming a user ID entry screen on which the user ID is input in communication with the content delivery terminal 100, and presents a screen shown in FIG. 9 based on the screen construction data. FIG. 9 shows the user ID entry screen.

Referring to FIG. 9, the user enters the user ID, the password, and the destination address to which the user desires the delivery of the digital content. The user enters the destination address, the user ID, and the password by inputting numerals and characters in text boxes 530-532 using a keyboard, etc. When the input of the user ID, etc. is complete, a button 526 labeled “ENTER” is clicked.

When the input of the user ID, etc., is complete, the user terminal 200 transmits the user ID, etc. to the content delivery terminal 100. In communication with the content delivery terminal 100, the user terminal 200 receives screen construction data of a category entry screen for designating a category of the digital content. Based on the screen construction data, the user terminal 200 presents a screen shown in FIG. 10. FIG. 10 shows the category entry screen.

Referring to FIG. 10, the user can designate up to six categories of digital contents desired by the user. The designation of the category of the digital content may be performed by selecting a desired category from among combo boxes 520-525, respectively having categories listed therewithin. The user enters the date and time of delivery desired by the user. The input of the date of delivery may be performed by selecting “EVERYDAY,” “EVERY WEEK,” “WEEKEND(SATURDAY, SUNDAY),” and “WEEKDAY (MONDAY FRIDAY),” respectively at option buttons 540-543. The time of delivery is input by selecting a desired time band from among combo boxes 550 and 551 registering a list of time bands. When the input of these pieces of data is complete, a button 552 labeled “ENTER” is clicked.

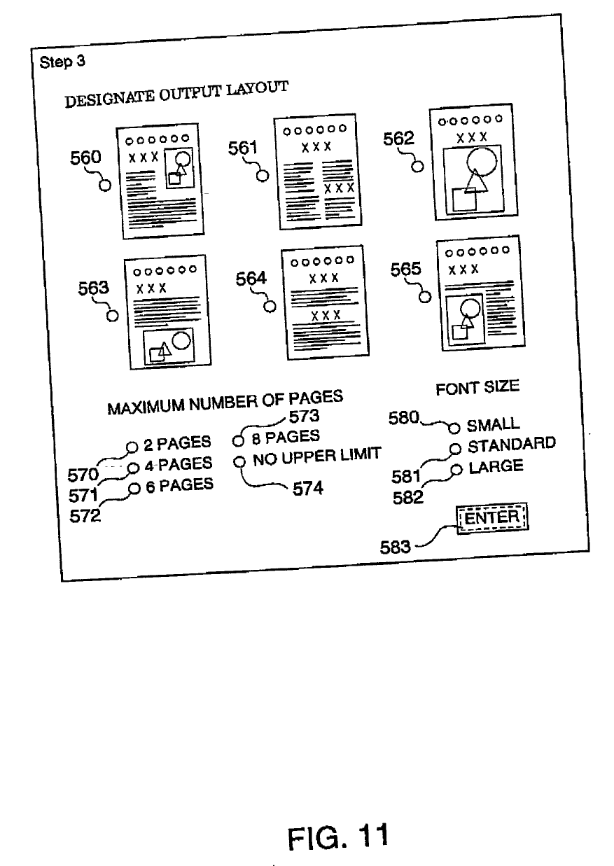

When the designation of the category is complete, the user terminal 200 transmits the designation of the category to the content delivery terminal 100. In communication with the content delivery terminal 100, the user terminal 200 receives screen construction data for forming an output layout entry screen for designating the output layout of the digital content, and displays a screen shown in FIG. 11 based on the screen construction data. FIG. 11 shows the output layout entry screen.

Referring to FIG. 11, the user enters the layout number, the maximum number of pages, and the font size. The layout number is entered by selecting one from six option buttons 560-565 corresponding to sample images laid out in accordance with the output layouts. The maximum number of pages is entered by selecting one of option buttons 570-574 respectively corresponding to the settings of “2 PAGES,” “4 PAGES,” “6 PAGES,”, “8 PAGES,” and “NO UPPER LIMIT.” The font size is entered by selecting one from option buttons 580-582 respectively corresponding to the settings of “SMALL,” “STANDARD,” and “LARGE.” When the entry of these settings is complete, a button 583 labeled “ENTER” is clicked.

When the designation of the output layout is complete, the user terminal 200 transmits the selected output layout to the content delivery terminal 100. In communication with the content delivery terminal 100, the user terminal 200 receives screen construction data of a user-designated information entry screen for entering the user-designated coupon information, the user-designated advertisement information, and the other user-designated information, and displays the user-designated information entry screen based on the screen construction data.

In the same manner as shown in FIG. 9 through FIG. 11, the category information, the area information, the period information, and the schedule information in connection with the user-designated coupon information and the user-designated advertisement information are input. The category information is input by selecting a desired category from combo box or a pull-down menu in which a plurality of categories are listed. The area information and the period information are input in the same manner as the category information or by entering a character string in a text box. The schedule information is input by entering a character string in a text box, for example, by entering “PERIOD: 12/2-12/4, PLACE: IZU.”

The other user-designated information designates, at the time of data reception, the data size and the date reception time, the quality of the digital content, the ratio of the text information to the picture, the type of information located in space left after the digital content is arranged, the type and the color of the font, the character pitch and the line pitch. The input of the other user-designated information is performed by inputting information in a text box for each item.

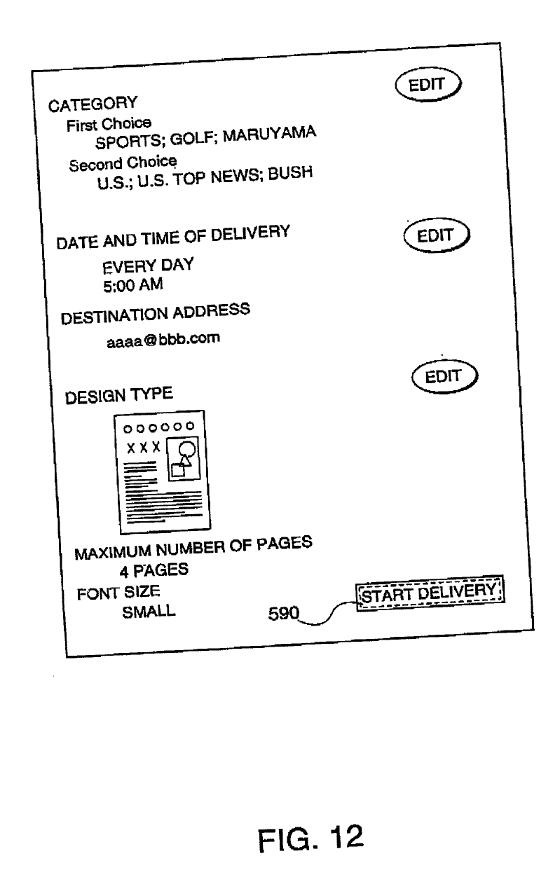

When the input of the user-designated coupon information, the user-designated advertisement information, and the other user-designated information is complete, these pieces of user-designated information are sent to the content delivery terminal 100. In communication with the content delivery terminal 100, the user terminal 200 receives screen construction data for forming a registration content verification screen for verifying a registration content. Based on the screen construction data, the user terminal 200 displays a screen shown in FIG. 12. FIG. 12 shows the registration content verification screen.

Referring to FIG. 12, “SPORTS; GOLF; MARUYAMA,” “U.S.; U.S. TOP NEWS; BUSH” are displayed as categories, “EVERYDAY,” and “5:00 A. M.” are displayed as the date and time of delivery, and “aaa@bbb.com” is displayed as the destination address. A sample image laid out in the output layout is displayed, “4 PAGES” is displayed as the maximum number of pages, and “SMALL” is displayed as the font size. When the user finds no error in the content of the registration, a button 590 labeled “START DELIVERY” is clicked.

When the verification of the registration content is complete, the user terminal 200 transmits the delivery start request to the content delivery terminal 100.

When the delivery start request is received, the content delivery terminal 100 registers, in the user profile table 300, the designation of the content received, and the designation of the user ID and the output layout in step S114. The designation of the content is registered as the content number referencing the category number definition table 340. The designation of the output layout is registered as the layout number referencing the layout number definition table 330.

The delivery of the digital content referencing the user profile table 300 will now be discussed.

The content delivery terminal 100 references the user profile table 300. When the content delivery terminal 100 determines that it is the day and time for delivery of the digital content, the content delivery terminal 100 reads the category number from the user profile table 300 in steps S204 and S206. The content delivery terminal 100 searches for the digital content in the content registration DB 42 based on the read category number, and retrieves a digital content having a category number equal to the read category number.

In steps S208 and S210, the user-designated coupon information is read from the user profile table 300. The CPU 30 searches for the coupon information in the coupon information registration DB 44 based on the read user-designated coupon information, and retrieves the coupon information matching the user-designated coupon information. In steps S212 and S214, the CPU 30 reads the user-designated advertisement information from the user profile table 300, and searches for the advertisement information in the advertisement information registration DB 46 based on the read user-designated advertisement information, and retrieves the advertisement information matching the user-designated advertisement information.

In steps S216-S220, the CPU 30 searches for the layout number from the user profile table 300. Upon referencing the layout number definition table 330, the CPU 30 reads a layout definition file from the user information registration DB 40 in accordance with the read layout number. Based on the read layout definition file, the layout is thus determined for the retrieved digital content, the coupon information, and the advertisement information, and a layout operation is thus performed.

In steps S222 and S224, the CPU 30 reads the other user-designated information from the user profile table 300, and determines again the output layout of the produced digital content in accordance with the read other user-designated information, and a layout operation is again performed.

In steps S226 and S228, the CPU 30 reads the destination address from the user profile table 300, and delivers the produced digital content to the read destination address.

The content delivery terminal 100 in this embodiment, composed of the user information registration DB 40 storing the information designated by the user, and the coupon information registration DB 44 registering the coupon information, searches for and retrieves the coupon information in the coupon information registration DB 44 in accordance with the user-designated coupon information in the user information registration DB 40. The content delivery terminal 100 adds the retrieved coupon information to the digital content, and delivers, to the user, the digital content to which the coupon information is attached.

Since the coupon information complying with the user's instruction is delivered, the user obtains the coupon information relatively agreeable with the user. Since the coupon information is effectively utilized by the user, the system issues the coupon information more needed by the user. Since the coupon information is transmitted together with the digital content, the user finds the coupon information while reading the digital content. The coupon information, which is easy to see, gives the user more chances to use the coupon information. The provider of the coupon information thus enjoys a large advertizing effect.

The content delivery terminal 100 in this embodiment, composed of the user information registration DB 40 storing the information designated by the user, and the advertisement information registration DB 46 registering the advertisement information, searches for and retrieves the advertisement information in the advertisement information registration DB 46 in accordance with the user-designated advertisement information in the user information registration DB 40. The content delivery terminal 100 adds the retrieved advertisement information to the digital content, and delivers, to the user, the digital content to which the advertisement information is already attached.

Since the advertisement information complying with the user's instruction is delivered, the user obtains the advertisement information relatively agreeable with the user's preference. Since the advertisement information is effectively utilized by the user, the system issues the advertisement information more needed by the user. Since the advertisement information is transmitted together with the digital content, the user finds the advertisement information while reading the digital content. The advertisement information, which is easy to see, gives the user more chances to use the advertisement information. The provider of the advertisement information thus enjoys a large advertizing effect.

In this embodiment, the user-designated coupon information is the information relating to the user's interest or preference and includes the category information indicating the category of the commodity or service for which the coupon information is issued, and the user-designated advertisement information is the information relating to the user's interest or preference and includes the category information indicating the category of the commodity or service for which the advertisement information is issued. The coupon information matching the user's interest or preference is searched for based on the category information out of the user-designated coupon information, and the advertisement information matching the user's interest or preference is searched for based on the category information out of the user-designated advertisement information.

The user thus obtains the coupon information and the advertisement information, matching the user's interest and preference and the coupon information and the advertisement information, much more needed by the user, are thus issued.

The user-designated coupon information in this embodiment includes the area information of the area within which the use of the coupon information is desired, the user-designated advertisement information includes the area information relating to the advertisement area of the advertisement information. The coupon information usable within the area desired by the user is searched for based on the area information of the user-designated coupon information, and the advertisement information relating to the area desired by the user is searched for based on the area information of the user-designated advertisement information.

The user thus obtains the coupon information usable within the area desired by the user and the advertisement information relating to the area desired by the user. The coupon information and the advertisement information, much more needed by the user, are thus issued.

The user-designated coupon information in this embodiment includes the period information within which the user desires to use the coupon. The user-designated advertisement information includes the period information indicating the advertisement period of the advertisement information. The coupon information usable within a predetermined time from the present moment is searched for based on the period information of the user-designated coupon information. The advertisement information remaining useful within a predetermined time from the present moment is searched for based on the period information of the user-designated advertisement information.

Since the user thus obtains the coupon information that is usable within a period of time desired by the user and the advertisement information that is useful within a period of time desired by the user, the coupon information and the advertisement information, much more needed by the user, are issued.

In this embodiment, the user-designated coupon information includes the schedule information about the schedule of the user, and the user-designated advertisement information includes the schedule information about the schedule of the user. The coupon information appropriate for the schedule of the user is searched for based on the schedule information of the user-designated coupon information. The advertisement information most appropriate for the schedule of the user is searched for based on the schedule information of the user-designated advertisement information.

Since the user thus obtains the coupon information and the advertisement information most appropriate for the schedule of the user, the coupon information and the advertisement information, much needed by the user, are issued.

The content delivery terminal 100 in this embodiment determines the output layout of the digital content based on the other user-designated information in the user information registration DB 40 and performs a layout operation on the digital content.

Since the output layout accounts for the information designated by the user, the digital content is output in the output layout relatively satisfying the user. In comparison with the conventional art, the digital content is output in an easy-to-see output layout to the user.

The print layout is also determined in this embodiment. The digital content is printed out on sheets of paper on a page by page basis. In a layout adopted, the content on each page is closed on a page by page basis, rather than appears straddling on a succeeding page. In this way, only a desired page may be printed after viewing that page. In a layout in which each page is dated, the user may store the digital content in a file, and may conveniently learn the age of the digital content by the date.

In this embodiment, the content delivery terminal 100 includes the content registration DB 42 storing a plurality of digital contents. The content delivery terminal 100 reads the content number and the layout definition file of the content number from the user information registration DB 40, selects the digital content from the content registration DB 42 based on the read content number, determines the output layout of the selected digital content, the coupon information, and the advertisement information based on the read layout definition file, and lays out the digital content.

Only the digital content relatively close to the user's satisfaction is laid out. This arrangement reduces the difficulty of seeing which would be increased if undesired and unnecessary digital content were laid out together with the desired digital content in a mixed fashion. The digital content is thus output in an easy-to-see layout to the user.

In this embodiment, the content delivery terminal 100 delivers the produced digital content in accordance with the date and time of delivery specified by the layout definition file used in the layout of the digital content.

Since the digital content is thus delivered within the time band relatively agreeable to the user's preference , the system can provide a delivery service to the user's satisfaction compared with the conventional art.

In this embodiment, the coupon information corresponds to the bonus information stated in each of claims 1, 3, 5, and 8 through 12, the category information corresponds to the preference information stated in claim 8, the user information registration DB 40 corresponds to the user information storage means stated in each of claims 1, 6, and 8 through 13, and the content registration DB 42 corresponds to the content storage means stated in claim 6. Steps S204 and S206 correspond to the content selecting means stated in claim 6, steps S208 and S210 correspond to the bonus information production means stated in each of claims 1, 3, 5, and 8 through 12, and steps S212 and S214 correspond to the advertisement information production means stated in each of claims 2, 4, 5, and 8 through 11, and 13. Steps S216-S220 correspond to the content layout means stated in claim 5, step S220 corresponds to the bonus information association means stated in each of claims 3 and 4, or the advertisement information association means stated in each of claims 3 and 4, step S228 corresponds to the bonus information issuing means in each of claims 1 and 12, the advertisement information issuing means stated in each of claims 2 and 13, or the content delivery means in each of claims 3, 4, and 5.

In this embodiment, the coupon information is searched for based on the user-designated coupon information containing the category information, the area information, the period information, and the schedule information. The present invention is not limited to this arrangement. Alternatively, the coupon information may be searched for by the number of times equal to the number of deliveries of the digital content. The coupon information may be issued more frequently or the coupon information with a high score of bonus may be issued to the user who reads more often a week.

In the above embodiment, each of the user-designated coupon information and the user-designated advertisement information contains the category information, the area information, the period information, and the schedule information. The present invention is not limited to this arrangement. Each of the user-designated coupon information and the user-designated advertisement information may contain information about a provider of the coupon information or the advertisement information, or information about the score of bonus of the coupon information. When the provider of the coupon information is contained, the user may designate a corporate appealing to the user, and may obtain the coupon information and the advertisement information of that corporate.

In the above embodiment, each of the coupon information and the advertisement information is attached to the digital content, and is then delivered. The present invention is not limited to this arrangement. The coupon information and the advertisement information, to be added to the digital content, may be stored in the WWW server in the Internet 199, and the digital content may be delivered with a URL indicating the storage location thereof attached thereto.

In this case, there is available a URL link library in which the coupon information and the advertisement information are collected, and the digital content is delivered with a URL indicating the storage location thereof attached thereto. Without a correct password, nobody can access the URL link library. The correct password is supplied to the user when the digital content is delivered. The URL link library may be composed of the coupon information or the advertisement information relating to the article content delivered to the user, or may be composed of the coupon information or the advertisement information based on the profile of the user, or may be composed of the coupon information or the advertisement information designated by the user.

The content delivery terminal 100 performs the layout process in steps S220 and S224 in this embodiment. The present invention is not limited to this arrangement. The layout process may be performed by the user terminal 200, and this arrangement prevents workload from being concentrated on the content delivery terminal 100.

The user terminal 200 in the above embodiment accesses the content delivery terminal 100 using the WWW browser. The present invention is not limited to this arrangement. As long as an application has a communication function to access the content delivery terminal 100, the user terminal 200 can gain access using such an application.

In the above embodiment, the processes shown in the flow diagrams in FIG. 7 and FIG. 8 are performed by executing a control program stored beforehand in the ROM 32. The present invention is not limited to this. Before being executed, the processes shown in the flow diagrams in FIG. 7 and FIG. 8 may be performed by reading, from a storage medium, a software program of the process into the RAM 34. Alternatively, such a software program may be downloaded from a network.

The storage medium may be a semiconductor storage medium such as an RAM, an ROM, etc, a magnetic storage medium such as an FD, an HD, etc, an optical storage medium such as a CD, a CDV, an LD, a DVD, etc., or a magnetooptical storage medium such as an MO, etc. The storage medium is thus any computer readable storage medium that permits data to be read electronically, magnetically, or optically.

In the above embodiment, the bonus information issuing system, the advertisement information issuing system, the digital content delivery system, and the storage medium of the present invention are implemented in a network system such as the Internet 199. The present invention is not limited to this arrangement. Alternatively, the present invention may be applied to a so-called intranet that performs the same communication method as that of the Internet 199. The present invention is not limited to a network that performs the same communication method as that of the Internet 199, and may be applied to an ordinary network.

In the bonus information issuing system, the advertisement information issuing system, the digital content delivery system, and the storage medium of the present invention, the content delivery terminal 100 delivers digital contents such as news to the user terminal 200 as shown in FIG. 1. The present invention is not limited to this arrangement, and may be applied to other system configuration without departing from the scope and spirit of the present invention.

As discussed above, the bonus information issuing system of the present invention as recited in claim 1 delivers the bonus information designated by the user. The user thus obtains the bonus information relatively agreeable to the user's preference. Since the bonus information is expected to be utilized more effectively by the user, the system issues the bonus information more needed by the user in contrast to the conventional art.

The advertisement information issuing system of the present invention as recited in claim 2 delivers the advertisement information in accordance with the information designated by the user. The user thus obtains the advertisement information relatively agreeable to the user's preference. Since the advertisement information is expected to be utilized more effectively by the user, the system issues the advertisement information more needed in contrast to the conventional art.

The digital content delivery system of the present invention as recited in claim 3 delivers the bonus information in accordance with the information designated by the user. The user thus obtains the bonus information relatively agreeable to himself. Since the bonus information is expected to be utilized more effectively by the user, the system issues the bonus information more needed by the user than the conventional art. Since the bonus information is delivered together with the digital content, the user learns the bonus information while reading the digital content. The bonus information, which is easy to see, gives the user more chances to use the bonus information.

The digital content delivery system of the present invention as recited in claim 4 delivers the advertisement information in accordance with the information designated by the user. The user thus obtains the advertisement information relatively agreeable to the user's preference. Since the advertisement information is expected to be utilized more effectively by the user, the system issues the advertisement information more needed by the user than the conventional art. Since the advertisement information is delivered together with the digital content, the user learns the advertisement information while reading the digital content. The advertisement information, which is easy to see, gives the user more chances to use the advertisement information.

In addition to the advantages provided by the digital content delivery system of each of claims 3 and 4, the digital content delivery system of the present invention as recited in each of claims 5 through 11 accounts for the information designated by the user in the output layout. The system thus outputs the digital content at the output layout relatively agreeable to the user's preference, and thus outputs the digital content in an easy-to-see output layout to the user.

The digital content delivery system of the present invention as recited in claim 6 lays out only the digital content agreeable to the user's preference. This arrangement reduces the difficulty of seeing which would be increased if undesired and unnecessary digital content were laid out together with the desired digital content in a mixed fashion. The digital content is thus output in an easy-to-see layout to the user.

The digital content delivery system of the present invention as recited in claim 8 allows the user to obtain the bonus information and the advertisement information agreeable to the user's interest or preference, and the bonus information and the advertisement information much more needed by the user are issued.

The digital content delivery system of the present invention as recited in claim 9 allows the user to obtain the bonus information usable within the area desired by the user and the advertisement information about the area desired by the user, and the bonus information and the advertisement information, much more needed by the user, are issued.

The digital content delivery system of the present invention as recited in claim 10 allows the user to obtain the bonus information usable within the period desired by the user and the advertisement information useful within the period desired by the user, and the bonus information and the advertisement information, much more needed by the user, are issued.

The digital content delivery system of the present invention as recited in claim 11 allows the user to obtain the bonus information and the advertisement information most appropriate for the schedule of the user, and the bonus information and the advertisement information, much more needed by the user, are issued.

The storage medium of the present invention as recited in claim 12, storing the bonus information issuing software program, provides the same advantages as those of the bonus information issuing system of claim 1.

The storage medium of the present invention as recited in claim 13, storing the advertisement information issuing software program, provides the same advantages as those of the advertisement information issuing system of claim 2.

What is claimed is:

1. A bonus information issuing system for issuing bonus information for gaining a bonus or bonus information itself serving as a bonus, comprising user information storage means for storing user information containing information designated by a user, bonus information production means for producing the bonus information based on the user-designated information in the user information storage means, and bonus information issuing means for issuing, to the user, the bonus information produced by the bonus information production means.

2. An advertisement information issuing system for issuing advertisement information for an advertisement, comprising user information storage means for storing user information containing information designated by a user, advertisement information production means for producing the advertisement information based on the user-designated information in the user information storage means, and advertisement information issuing means for issuing, to the user, the advertisement information produced by the advertisement information production means.

3. A digital content delivery system for delivering a digital content, comprising user information storage means for storing user information containing information designated by a user, bonus information production means for producing bonus information for gaining a bonus or bonus information itself serving as a bonus, based on the user-designated information in the user information storage means, bonus information association means for associating the bonus information produced by the bonus information production means with the digital content so that the bonus information is gained, and content delivery means for delivering, to the user, the digital content with which the bonus information is associated by the bonus information association means.

4. A digital content delivery system for delivering a digital content, comprising user information storage means for storing user information containing information designated by a user, advertisement information production means for producing advertisement information for an advertisement, based on the user-designated information in the user information storage means, advertisement information association means for associating the advertisement information produced by the advertisement information production means with the digital content so that the advertisement information is read, and content delivery means for delivering, to the user, the digital content with which the advertisement information is associated by the advertisement information association means.

5. A digital content delivery system for delivering a digital content, comprising user information storage means for storing user information containing information designated by a user, bonus information production means for producing bonus information for gaining a bonus or bonus information itself serving as a bonus, based on the user-designated information in the user information storage means, advertisement information production means for producing advertisement information based on the user-designated information in the user information storage means, content layout means for laying out the digital content after determining an output layout of the digital content based on the user-designated information in the user information storage means, bonus information association means for associating the bonus information produced by the bonus information production means with the digital content laid out by the content layout means so that the bonus information is gained, advertisement information association means for associating the advertisement information produced by the advertisement information production means with the digital content laid out by the content layout means so that the advertisement information is read, and content delivery means for delivering, to the user, the digital content with which the bonus information and the advertisement information are associated respectively by the bonus information association means and the advertisement information association means.

6. A digital content delivery system according to claim 5, further comprising content storage means for storing a plurality of digital contents, and content selecting means for selecting the digital content in the content storage means based on the user-designated information in the user information storage means,
wherein the content layout means lays out the digital content based on the user-designated information in the user information storage means after determining an output layout of the digital content that is selected by the content selecting means.

7. A digital content delivery system according to one of claims 5 and 6, wherein the bonus information production means produces the bonus information by the number of times equal to the number of deliveries of the digital content.

8. A digital content delivery system according to one of claims 5 through 7, wherein the user information contains preference information relating to the user's interest or preference.
the bonus information production means produces the bonus information to the user's interest or preference based on the preference information in the user information storage means, and
the advertisement information production means produces the advertisement information to the user's interest or preference based on the preference information in the user information storage means.

9. A digital content delivery system according to one of claims 5 through 8, wherein the user information contains area information relating to a local area desired by the user,
the bonus information production means produces the bonus information to gain a bonus within the user-desired local area based on the area information in the user information storage means, and
the advertisement information production means produces the advertisement information relating to the user-desired local area based on the area information in the user information storage means.

10. A digital content delivery system according to one of claims 5 through 9, wherein the user information contains period information relating to a period desired by the user,
the bonus information production means produces the bonus information to gain a bonus within a predetermined period starting from the present moment based on the period information in the user information storage means, and
the advertisement information production means produces useful advertisement information within a predetermined period starting from the present moment based on the period information in the user information storage means.

11. A digital content delivery system according to one of claims 5 through 10, wherein the user information contains schedule information relating to a schedule of the user,
the bonus information production means produces the bonus information most appropriate for the schedule of the user based on the schedule information in the user information storage means, and
the advertisement information production means produces the advertisement information most appropriate for the schedule of the user based on the schedule information in the user information storage means.

12. A storage medium storing a computer readable bonus issuing software program for issuing bonus information for gaining a bonus or bonus information itself serving as a bonus, wherein in a computer comprising user information storage means for storing user information containing information designated by a user, the software program controls a process to be carried out by bonus information production means for producing the bonus information based on the user-designated information in the user information storage means, and by bonus information issuing means for issuing, to the user, the bonus information produced by the bonus information production means.

13. A storage medium storing a computer readable advertisement issuing software program for issuing advertisement information relating to an advertisement, wherein in a computer comprising user information storage means for storing user information containing information designated by a user, the software program controls a process to be carried out by advertisement information production means for producing the advertisement information based on the user-designated information in the user information storage means, and by advertisement information issuing means for issuing, to the user, the advertisement information produced by the advertisement information production means.
